(19) United States
(12) Patent Application Publication
(10) Pub. No.: US 2010/0130068 A1
(43) Pub. Date: May 27, 2010

(54) Board-to-board connector assembly

(76) Inventor: Yung-Chi Peng, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,711

(22) Filed: Nov. 25, 2008

(51) Int. Cl. H01R 24/00

(52) U.S. Cl. 439/660

(57) ABSTRACT

A board-to-board connector assembly includes a receptacle connector having a plurality of first terminals, and a plug connector having a plurality of second terminals. Each of the first terminals has a first contact portion and a second contact portion and each of the second terminals has a first contact arm and a second contact arm. When the plug connector is mated with the receptacle connector, the first contact portion and the second contact portion of the first terminal electrically contact the first contact arm and the second contact arm of the corresponding second terminal respectively to make the first terminal and the corresponding second terminal electrically interconnected steadily.

### BACKGROUND OF THE INVENTION

1. Field of the Invention

The present invention generally relates to an electrical connector, and more particularly to a board-to-board connector assembly.

2. The Related Art

A conventional board-to-board connector assembly includes a receptacle connector and a plug connector. The receptacle connector has a plurality of first terminals each having a contact portion. The plug connector has a plurality of second terminals each having a contact arm. When the plug connector is mated with the receptacle connector, the contact portions electrically contact the corresponding contact arms to make the first terminals and the corresponding second terminals electrically interconnected. However, each of the first terminals contacts the respective second terminal merely in one single point. As a result, when the board-to-board connector assembly is shaken in use, the contact portion is apt to depart from the corresponding contact arm that makes signal transmission between the first terminal and the corresponding second terminal broken easily. Therefore, a board-to-board connector assembly capable of overcoming the above-mentioned problems is required.

### SUMMARY OF THE INVENTION

An object of the present invention is to provide a board-to-board connector assembly including a receptacle connector and a plug connector mated with the receptacle connector. The receptacle connector includes a receptacle housing having a flat base board and two sidewalls protruding upward from two opposite sides of the base board and extending longwise, and a plurality of first terminals. A receiving recess is defined between the sidewalls. Each of the sidewalls defines a plurality of first passageways extended longitudinally to the base board and communicating with the receiving recess for receiving the respective first terminals therein. Each of the first terminals has a bar-shaped base portion extending longitudinally. Two opposite ends of the base portion extend oppositely and longitudinally to form a first soldering portion and a first elastic portion inclining upward. A free end of the first elastic portion protrudes upward to form a first contact portion stretching into the receiving recess. The base portion further extends upward to form a first fixing portion adjacent to the first soldering portion and a second elastic portion adjacent to the first elastic portion. The second elastic portion inclines toward the first elastic portion and a free end thereof protrudes toward the first contact portion to form a second contact portion stretching into the receiving recess. The plug connector includes a plug housing having a base body received in the receiving recess of the receptacle housing, and a plurality of second terminals disposed at two sides of the base body. Two opposite outsides of the plug housing define a plurality of second passageways. Each of the second terminals has a second fixing portion fastened in the base body and extending vertically. A bottom end of the second fixing portion extends longitudinally and inclines downward to form a first contact arm stretching out of a bottom surface of the base body. A free end of the first contact arm extends upward to form a second contact arm inclining toward the second fixing portion and received in the corresponding second passageway. A top end of the second contact arm extends longitudinally to form a second soldering portion protruding out of the base body. Wherein the first elastic portion and the second elastic portion of the first terminal elastically clip the first contact arm and the second contact arm of the corresponding second terminal therebetween, the first contact portion and the second contact portion of the first terminal elastically contact the first contact arm and the second contact arm of the corresponding second terminal respectively.

As described above, the board-to-board connector assembly of the present invention utilizes the first contact portion and the second contact portion to elastically contact the first contact arm and the second contact arm respectively so that the first terminal and the second terminal can be always electrically connected with each other steadily even if the board-to-board connector assembly is shaken. Furthermore, the first elastic portion and the second elastic portion respectively cooperate with the first contact arm and the second contact arm to enable the plug connector to be restored to a right position in the receptacle connector that further ensures the first terminal and the second terminal electrically connected with each other steadily.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of a board-to-board connector assembly in accordance with the present invention;

FIG. 2 is a perspective view of the board-to-board connector assembly of FIG. 1;

FIG. 3 is a perspective view of a plug connector of the board-to-board connector assembly of FIG. 1;

FIG. 4 is a perspective view of a receptacle connector of the board-to-board connector assembly of FIG. 1;

FIG. 5 is a cross-sectional view of a receptacle housing of the board-to-board connector assembly of FIG. 1, wherein a first auxiliary member is assembled in the receptacle housing;

FIG. 6 is a cross-sectional view of the receptacle connector along line VI-VI of FIG. 4;

FIG. 7 is a cross-sectional view of the plug connector along line VII-VII of FIG. 3; and

FIG. 8 is a cross-sectional view of the board-to-board connector assembly along line VIII-VIII of FIG. 2.

### DETAILED DESCRIPTION OF THE PREFERRED EMBODIMENT

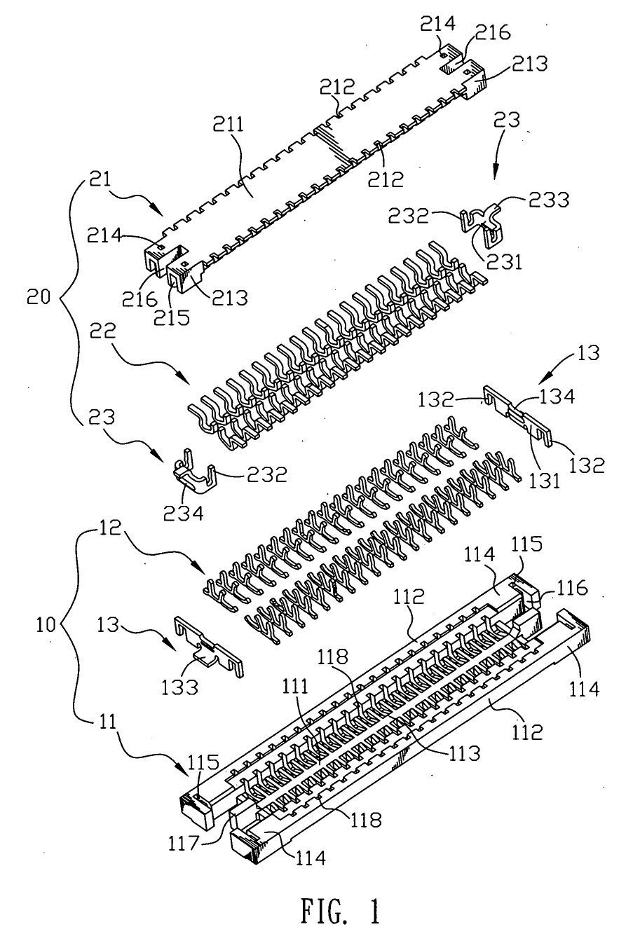

With reference to FIG. 1, a board-to-board connector assembly in accordance with the present invention is composed of a receptacle connector 10 and a plug connector 20 which are respectively mounted to a female and a male printed circuit boards (not shown) to make the printed circuit boards electrically connected with each other.

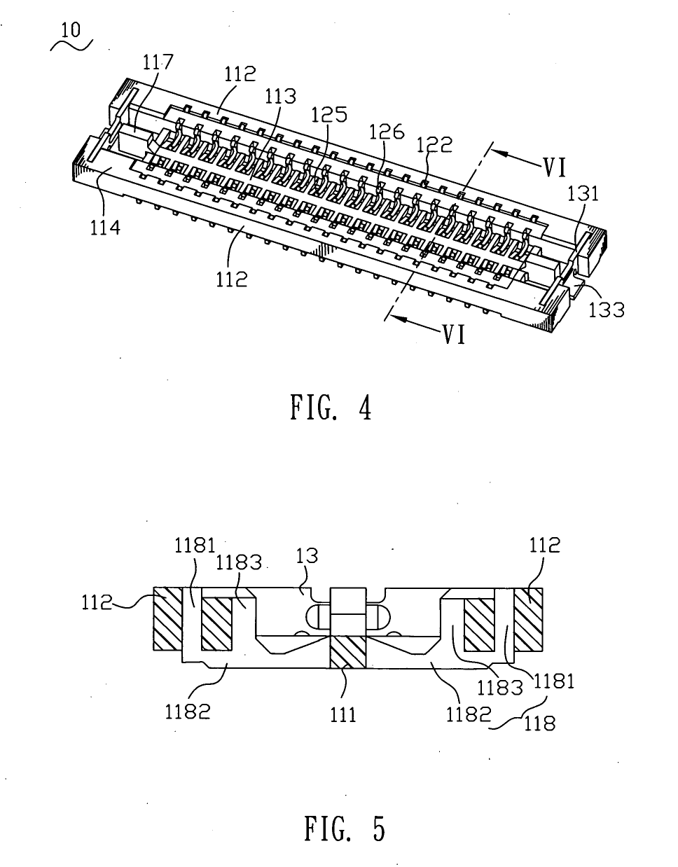

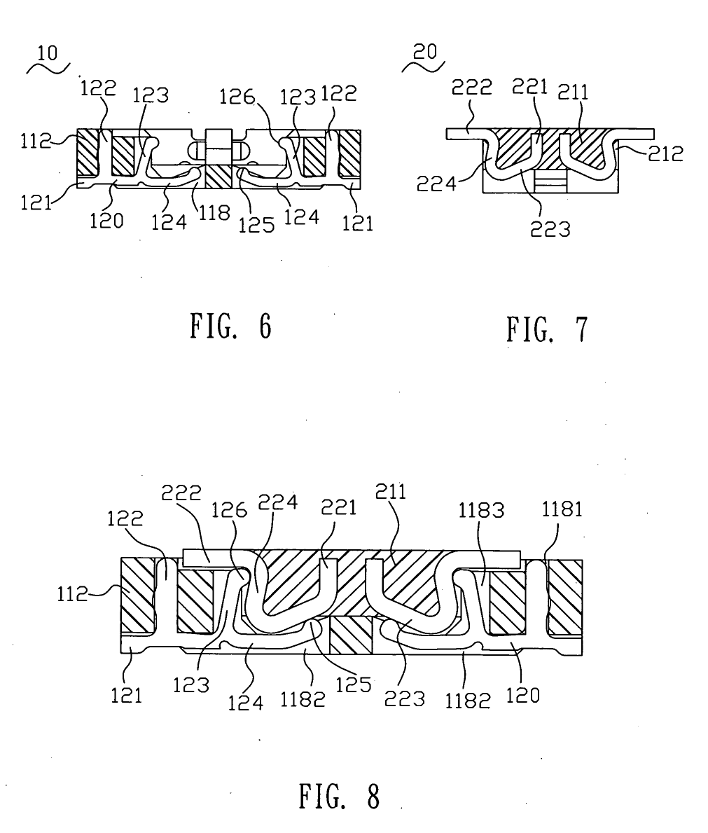

Referring to FIGS. 1, 4, 5 and 6, the receptacle connector 10 includes a receptacle housing 11, a plurality of first terminals 12 and two first auxiliary members 13 disposed in the receptacle housing 11 respectively.

The receptacle housing 11 has a rectangular base board 111 disposed levelly. Two opposite sides of the base board 111 protrude upward to form a pair of sidewalls 112 extending longwise and defining a receiving recess 113 therebetween. Two opposite ends of each sidewall 112 oppositely extend outward to respectively form a first end-wall 114. Each first end-wall 114 defines a first fixing aperture 115 vertically passing therethrough. An inside of the first end-wall 114 further defines a first fixing groove 116 vertically passing therethrough and longitudinally communicated with the corresponding first fixing aperture 115 at top. A middle portion of each of two opposite ends of the base board 111 protrudes outward to form a rectangular locating board 117 located vertically between the two corresponding first end-walls 114. The locating board 117 is higher than the base board 111 and has a substantially same height as the sidewall 112. A free end of the locating board 117 is spaced away from a vertical plane on which the first fixing aperture 115 and the corresponding first fixing groove 116 are located. Each of the sidewalls 112 defines a plurality of first passageways 118 arranged at regular intervals along a longwise direction thereof. Bottom ends of the first passageways 118 are further extended to the base board 111. Each of the first passageways 118 has a fixing perforation 1181 vertically passing through the corresponding sidewall 112, a receiving cavity 1182 extending longitudinally from a bottom end of the fixing perforation 1181 to the base board 111 and further penetrating through the base board 111 vertically to communicate with the receiving recess 113, and a receiving channel 1183 passing vertically through an inside of the corresponding sidewall 112 to communicate with the receiving recess 113 and further having a bottom end communicated with the corresponding receiving cavity 1182.

Each of the first terminals 12 has a bar-shaped base portion 120 extending longitudinally. Two opposite ends of the base portion 120 extend oppositely and longitudinally to form a first soldering portion 121 and a first elastic portion 124 inclining upward slightly. A free end of the first elastic portion 124 protrudes upward to form a first contact portion 125. The two ends of the base portion 120 further extend upward to form a first fixing portion 122 adjacent to the first soldering portion 121 and a second elastic portion 123 adjacent to the first elastic portion 124. The second elastic portion 123 inclines slightly toward the first elastic portion 124 and a free end thereof protrudes toward the first contact portion 125 to form a second contact portion 126.

Each of the first auxiliary members 13 has a rectangular first base plate 131 extending longitudinally and disposed vertically. Two opposite ends of a top of the first base plate 131 protrude oppositely and longitudinally and then extend downward to form a pair of first fixing arms 132. A middle portion of the top of the first base plate 131 defines a receiving fillister 134 and a middle portion of a bottom thereof bends sideward to form a first soldering foot 133.

When the receptacle connector 10 is to be assembled, the first terminals 12 are received in the corresponding first passageways 118 of the receptacle housing 11. The first fixing portion 122 is inserted in the respective fixing perforation 1181. The base portion 120 and the first elastic portion 124 are received in the corresponding receiving cavity 1182 and the first contact portion 125 stretches into the receiving recess 113. The second elastic portion 123 is received in the corresponding receiving channel 1183 and the second contact portion 126 stretches into the receiving recess 113. The first soldering portion 121 is located under the corresponding sidewall 112 for being soldered to the female printed circuit board to electrically connect with each other. The first auxiliary members 13 are mounted to two ends of the receptacle housing 11 and across the corresponding first end-walls 114. Two ends of the first base plate 131 are buckled into the corresponding first fixing grooves 116 and the first fixing arms 132 are inserted in the respective first fixing apertures 115. The first base plate 131 is spaced away from the free end of the corresponding locating board 117. The first soldering foot 133 is located back to the locating board 117 and between the corresponding first end-walls 114 to be soldered to the female printed circuit board for ensuring that the first terminals 12 are electrically connected with the female printed circuit board steadily.

Referring to FIGS. 1, 3 and 7, the plug connector 20 includes a plug housing 21 mated with the receptacle housing 11, a plurality of second terminals 22 and two second auxiliary members 23 disposed in the plug housing 21 respectively.

The plug housing 21 has a rectangular base body 211 corresponding to the receiving recess 113 of the receptacle housing 11. Two opposite sides of the base body 211 define a plurality of second passageways 212 arranged at regular intervals along a longwise direction thereof. Two opposite ends of the base body 211 oppositely extend outward to respectively form a second end-wall 213. A middle portion of each of the second end-walls 213 defines a rectangular locating slot 216 vertically and transversely passing therethrough. Each second end-wall 213 further defines a pair of second fixing apertures 214 vertically passing therethrough and located at two sides of the corresponding locating slot 216. A bottom end of each second fixing aperture 214 transversely extends outward and then extends upward to form a second fixing groove 215 passing through an outside of the corresponding second end-wall 213.

Each of the second terminals 22 has a second fixing portion 221 extending vertically. A bottom end of the second fixing portion 221 extends longitudinally and inclines downward to form a first contact arm 223. A free end of the first contact arm 223 extends upward to form a second contact arm 224 slightly inclining toward the second fixing portion 221. A top end of the second contact arm 224 extends longitudinally and oppositely the second fixing portion 221 to form a second soldering portion 222.

Each of the second auxiliary members 23 has a rectangular second base plate 231 extending longitudinally and disposed vertically. Two opposite ends of a bottom of the second base plate 231 bend toward one side and then extend upward to form a pair of second fixing arms 232 facing each other. A middle portion of a top of the second base plate 231 bends toward the other side opposite the second fixing arms 232 and then extends to form a second soldering foot 233. The second base plate 231 further protrudes toward the same side as the second soldering foot 233 to form a fastening rib 234 on a bottom middle.

When the plug connector 20 is to be assembled, the second fixing portion 221 of each second terminal 22 is fastened in the base body 211 of the plug housing 21 and the first contact arm 223 stretches out of a bottom surface of the base body 211. The second contact arm 224 is received in the respective second passageway 212. The second soldering portion 222 stretches out of the corresponding side of the base body 211 for being soldered to the male printed circuit board to electrically connect with each other. The second auxiliary members 23 are mounted to the respective second end-walls 213 of the plug housing 21. Two ends of the second base plate 231 are buckled into the corresponding second fixing grooves 215 and the second fixing arms 232 are inserted in the respective second fixing apertures 214. The second base plate 231 is located across the corresponding locating slot 216. The second soldering foot 233 is located back to the locating slot 216 to be soldered to the male printed circuit board for ensuring that the second terminals 22 are electrically connected with the male printed circuit board steadily.

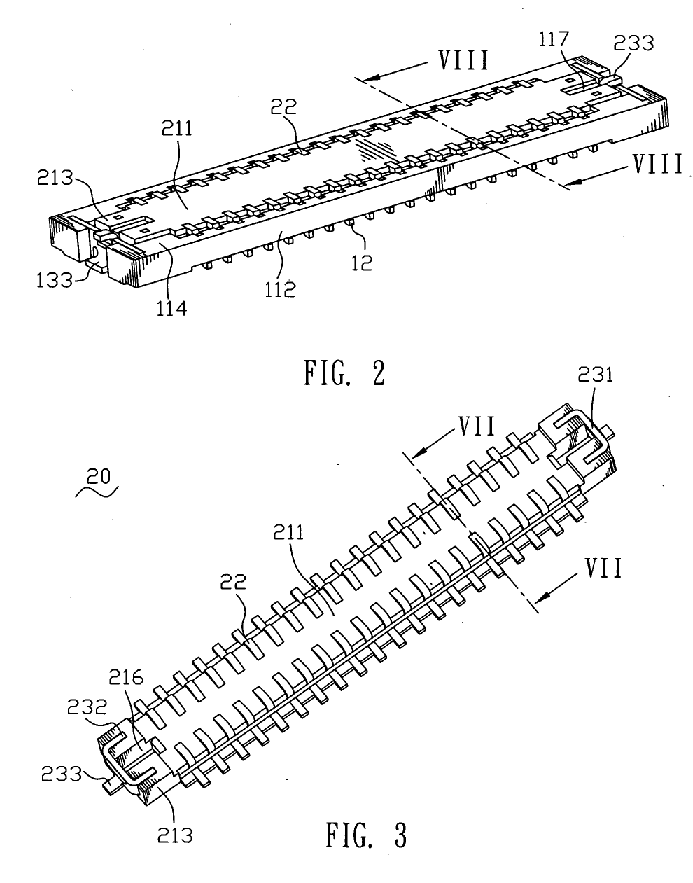

Referring to FIGS. 1, 2 and 8, when the plug connector 20 is engaged with the receptacle connector 10, the base body 211 of the plug housing 21 is received in the receiving recess 113 of the receptacle housing 11 to make the first terminals 12 electrically connected with the respective second terminals 22, wherein the first contact portion 125 electrically abuts against the corresponding first contact arm 223 and the second contact portion 126 electrically abuts against the corresponding second contact arm 224. The second end-walls 213 are disposed between the corresponding first end-walls 114 and the locating board 117 is inserted in the corresponding locating slot 216. The fastening rib 234 of the second auxiliary member 23 abuts against an inside of the first base plate 131 of the corresponding first auxiliary member 13 and the second soldering foot 233 is partially received in the receiving fillister 134. So the plug connector 20 can be engaged with the receptacle connector 10 firmly.

In use, when the plug connector 20 moves downward relatively to the receptacle connector 10, the contact between the first contact portion 125 and the first contact arm 223 is further enhanced because of the first elastic portion 124 inclining upward such that ensures the first terminals 12 and the second terminals 22 electrically connected with each other steadily. When the plug connector 20 moves upward relatively to the receptacle connector 10, the contact between the second contact portion 126 and the second contact arm 224 is further enhanced because of the second elastic portion 123 cooperated with the corresponding second contact arm 224 such that ensures the first terminals 12 and the second terminals 22 electrically connected with each other steadily. Furthermore, the relative elasticity of the first elastic portion 124 and the second elastic portion 123 cooperates with the first contact arm 223 and the second contact arm 224 to enable the plug connector 20 to be restored to a right position in the receptacle connector 10. Therefore, the first terminals 12 can be always electrically connected with the corresponding second terminals 22 so as to further ensure the printed circuit boards electrically connected with each other steadily.

As described above, the board-to-board connector assembly of the present invention utilizes the first contact portion 125 and the second contact portion 126 to elastically abut against the first contact arm 223 and the second contact arm 224 respectively so that the first terminals 12 and the second terminals 22 can be always electrically connected with each other steadily even if the board-to-board connector assembly is shaken. Furthermore, the first elastic portion 124 and the second elastic portion 123 respectively cooperate with the first contact arm 223 and the second contact arm 224 to enable the plug connector 20 to be restored to a right position in the receptacle connector 10 that further ensures the first terminal 12 and the second terminal 22 electrically connected with each other steadily.

What is claimed is:

1. A board-to-board connector assembly, comprising:
a receptacle connector having
a receptacle housing having a flat base board and two sidewalls protruding upward from two opposite sides of the base board and extending longwise, a receiving recess being defined between the sidewalls, each of the sidewalls defining a plurality of first passageways extended longitudinally to the base board and communicating with the receiving recess, and
a plurality of first terminals received in the respective first passageways and each having a bar-shaped base portion extending longitudinally, two opposite ends of the base portion extending oppositely and longitudinally to form a first soldering portion and a first elastic portion inclining upward, a free end of the first elastic portion protruding upward to form a first contact portion stretching into the receiving recess, the base portion further extending upward to form a first fixing portion adjacent to the first soldering portion and a second elastic portion adjacent to the first elastic portion, the second elastic portion inclining toward the first elastic portion and a free end thereof protruding toward the first contact portion to form a second contact portion stretching into the receiving recess; and
a plug connector mated with the receptacle connector, the plug connector having
a plug housing having a base body received in the receiving recess of the receptacle housing, two opposite outsides of the base body defining a plurality of second passageways, and
a plurality of second terminals disposed at two sides of the base body and each having a second fixing portion fastened in the base body and extending vertically, a bottom end of the second fixing portion extending longitudinally and inclining downward to form a first contact arm stretching out of a bottom surface of the base body, a free end of the first contact arm extending upward to form a second contact arm inclining toward the second fixing portion and received in the corresponding second passageway, a top end of the second contact arm extending longitudinally to form a second soldering portion protruding out of the base body;
wherein the first elastic portion and the second elastic portion of the first terminal elastically clip the first contact arm and the second contact arm of the corresponding second terminal therebetween with the first contact portion and the second contact portion.

2. The board-to-board connector assembly as claimed in claim 1, wherein each of the first passageways has a fixing perforation vertically passing through the corresponding sidewall, a receiving cavity extending longitudinally from a bottom end of the respective fixing perforation to the base board and communicating with the receiving recess, and a receiving channel passing vertically through the corresponding sidewall to communicate with the receiving recess and having a bottom end communicating with the corresponding receiving cavity, the first fixing portion of the first terminal is inserted in the respective fixing perforation, the base portion and the first elastic portion are received in the corresponding receiving cavity, the second elastic portion is received in the corresponding receiving channel, the first soldering portion is located under the corresponding sidewall.

3. The board-to-board connector assembly as claimed in claim 1, wherein two opposite ends of each sidewall of the receptacle housing extend oppositely to respectively form a first end-wall, two opposite ends of the base body of the plug housing extend oppositely to respectively form a second end-wall disposed between the corresponding two first end-walls.

4. The board-to-board connector assembly as claimed in claim 3, wherein the receptacle connector further includes two first auxiliary members each having a first base plate extending longitudinally and mounted vertically across the corresponding two first end-walls, two opposite ends of a top of the first base plate protrude oppositely and then extend downward to form a pair of first fixing arms fastened in the respective first end-walls, a middle portion of the top of the first base plate defines a receiving fillister and a middle portion of a bottom thereof bends outward to form a first soldering foot located between the corresponding two first end-walls.

5. The board-to-board connector assembly as claimed in claim 4, wherein the plug connector further includes two second auxiliary members each having a second base plate extending longitudinally and mounted vertically to a free end of the corresponding second end-wall, two opposite ends of a bottom of the second base plate bend toward one side and then extend upward to form a pair of second fixing arms facing each other and fastened in the respective second end-wall, a middle portion of a top of the second base plate bends toward the other side opposite the second fixing arms to form a second soldering foot received in the receiving fillister of the corresponding first auxiliary member, the second base plate further protrudes toward the same side as the second soldering foot to form a fastening rib abutting against an inside of the first base plate of the corresponding first auxiliary member.

6. The board-to-board connector assembly as claimed in claim 3, wherein two opposite ends of the base board of the receptacle housing protrude outward to form a locating board respectively, each of the second end-walls of the plug housing defines a locating slot for fastening the respective locating board therein.
